(19) United States
(12) Patent Application Publication
(10) Pub. No.: US 2014/0046874 A1
(43) Pub. Date: Feb. 13, 2014

(54) REAL TIME DYNAMIC VEHICLE PARKING PRICE MANAGEMENT METHODS, SYSTEMS AND PROCESSOR-READABLE MEDIA

(71) Applicants: Faming Li, Solon, OH (US); Onno Zoeter, Grenibke (FR); Daniel H. Greene, Sunnyvale, CA (US); Yu-An Sun, Webster, NY (US)

(72) Inventors: Faming Li, Solon, OH (US); Onno Zoeter, Grenibke (FR); Daniel H. Greene, Sunnyvale, CA (US); Yu-An Sun, Webster, NY (US)

(73) Assignees: Palo Alto Research Center Incorporated, Palo Alto, CA (US); Xerox Corporation, Norwalk, CT (US)

(21) Appl. No.: 13/569,601

(22) Filed: Aug. 8, 2012

(51) Int. Cl. G07B 15/02

(52) U.S. Cl. 705/418

(57) ABSTRACT

A real time dynamic vehicle parking price management method, system and processor-readable medium. Two factors can be considered in determining the parking price: the real time occupancy level and the historic parking demand. An assured price that follows from a background schedule can be pre-determined based on a historic parking data. Future demand can be estimated based on the historic occupancy data and price and the assured price can be made proportional to the estimated demand. The assured price can be simplified to be intuitive and easy to remember. A real time parking price can be determined by an occupancy feedback control. A controller can be employed to track the occupancy and to suggest the parking price in real time based on an occupancy set point to improve economic efficiency and reduce cruising for parking.

### TECHNICAL FIELD

Embodiments are generally related to the field of vehicle parking management. Embodiments are also related to on-street parking management. Embodiments are additionally related to dynamic parking pricing arrangements with price assurance.

### BACKGROUND OF THE INVENTION

Urban parking space is a limited resource that needs to be properly managed. Today most cities have time limited on-street parking at rates below privately owned off-street parking. This results in cruising for parking when parking demand exceeds supply, leading to congestion and inefficient use of resource. Parking space must be managed with proper pricing and this pricing has to reflect time varying and location dependent demand. The price of parking will be higher when demand is higher, and this higher price will encourage rapid parking turnover.

Market based parking pricing link parking rates directly to demand and is gaining popularity for its economical efficiency and feasibility due to fast development of sensing and communication technologies, such as wireless parking sensing, network enabled pay station, GPS, and mobile apps, etc. The market based pricing can effectively reduce “cruising” vehicles going round and round a local area searching for free or cheap parking.

With market based pricing, some cities permit the price to float between a government specified boundary. Such boundary is quite wide and doesn't provide an idea regarding payment with respect to specific time/location. Hence it is hard for a user to plan a trip ahead of time and to determine parking fee. Also, the user may be charged by an arrival rate or an integral over parking period. The charging of arrival rate for the entire duration of stay will unfairly favor an earlier bird and encourage prolonged stay in a real time parking pricing scenario. Additionally, charging the price integral over the whole parking period may upset the user since the future rate is unknown at

Parking pricing schemes that use a pre-determined price profile can't catch the real time fluctuation in parking demand. Real-time occupancy feedback permits for a more flexible response to demand fluctuations. Such real-time occupancy feedback with a real-time controller results in a price that varies in real time. This poses uncertainty for trip planning and confusion for parking charge. For instance, a user may park the car at a time when the hourly rate is x, then after 1-hour parking the user comes to find the total charge is 0.5× or 3× (an integral of the price during the hour). While 0.5× is a pleasant surprise, 3× likely leads to frustration and a public relationship backfire.

Based on the foregoing, it is believed that a need exists for an improved real time dynamic vehicle parking price management system and method, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved vehicle parking management system and method.

It is another aspect of the disclosed embodiments to provide for an improved real time dynamic vehicle parking price management system and method.

It is yet another aspect of the disclosed embodiments to provide for an improved method for combining a background pricing schedule with a real time occupancy feedback control and a price assurance.

The aforementioned aspects and other objectives and advantages can now be achieved as described herein. A real time dynamic vehicle parking price management system and method is disclosed herein. An assured price that follows from a background schedule can be pre-determined based on a historic parking data. A demand can be estimated and the assured price can be made proportional to the demand based on a historic occupancy and corresponding price. A real time parking price can be determined by an occupancy feedback control to achieve higher occupancy level. A controller (PID controller) in association with a feedback control loop can be employed to track the occupancy and to adjust the parking price in real time based on an occupancy set point to improve an economic efficiency and reduce “cruising” for parking. The assured price can be published and updated at timescales much larger than the real-time pricing (e.g., every month). The assured price for a given duration can be presented to the user with real-time demand based influences introduced as a discount for an ex-ante and ex-post variant.

Initially, the assured price can be obtained from modeling and simulation with the historic occupancy data and can be made smooth and intuitive with averaging and approximation. A moving average can be applied for a smoothing and adaptive piecewise constant approximation (APCA) for a dimension reduction. The assured price can be iteratively updated to an upper bound to control prices in past N days. A price curve produced by the occupancy control can be element-wise upper bounded by the assured price. The assured price can be updated by counting a number of times the assured price is pushed by a control price. With the actual price of the past N days, an overlap between the actual price curve and the assured price can be determined by a histogram and an update proportional to the density of the overlap can be made. The assured price can also be updated by utilizing an element-wise upper bound of the control price as the new assured price. The parking occupancy can be controlled to a desired level with the rate constrained by a pre-defined rate curve.

The real-time feedback based off-set can be employed for an entire parking duration and smoothed out assuming a regression to the mean. If the real time rate is lower than the assured rate, the real time price can be paid. If the real time rate is higher than the assured rate, the assured price can be paid. In the ex-post payment variant, an off-set to a base schedule can be computed and a final price can be provided by an integral of the real-time rate. The price can be presented as discount to the assured price. In the ex-ante payment variant, the rates in the background schedule can be adjusted based on a difference between expected and observed demand at the start of a parking event. An assurance can be employed to bind the total parking price. Such an approach reduces the parking price uncertainty while maintaining good occupancy performance and increases an economic efficiency of the parking usage.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance the disclosed embodiments;

FIG. 2 illustrates a schematic view of a software system including a real time dynamic pricing module, an operating system, and a user interface, in accordance with the disclosed embodiments;

FIG. 3 illustrates a block diagram of real time dynamic vehicle parking price management system, in accordance with the disclosed embodiments;

FIG. 4 illustrates a block diagram of a feedback control unit with price assurance, in accordance with the disclosed embodiments;

FIG. 5 illustrates a high level flow chart of operations illustrating logical operational steps of a method for managing real time dynamic vehicle parking price by combining a background pricing schedule with a real time occupancy feedback control and a price assurance, in accordance with the disclosed embodiments;

FIG. 6 illustrates a high level flow chart of operations illustrating logical operational steps of a method for integrating price assurance and occupancy control, in accordance with the disclosed embodiments;

FIG. 7 illustrates a graph depicting simulation of an occupancy control with a smoothed assured price, n accordance with the disclosed embodiments;

FIG. 8 illustrates a graph depicting simulation of the occupancy control with the smoothed assured price with respect to a different day with different demand, in accordance with the disclosed embodiments;

FIG. 9 illustrates a graph depicting simulation of an occupancy control with a piecewise simplified assured price, in accordance with the disclosed embodiments; and

FIG. 10 illustrates a graph depicting simulation of the occupancy control with the piecewise simplified assured price with respect to different daily demand, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, WiMax, 802.11x, and cellular network or the connection can be made to an external computer via most third party supported networks (e.g., through the Internet via an Internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

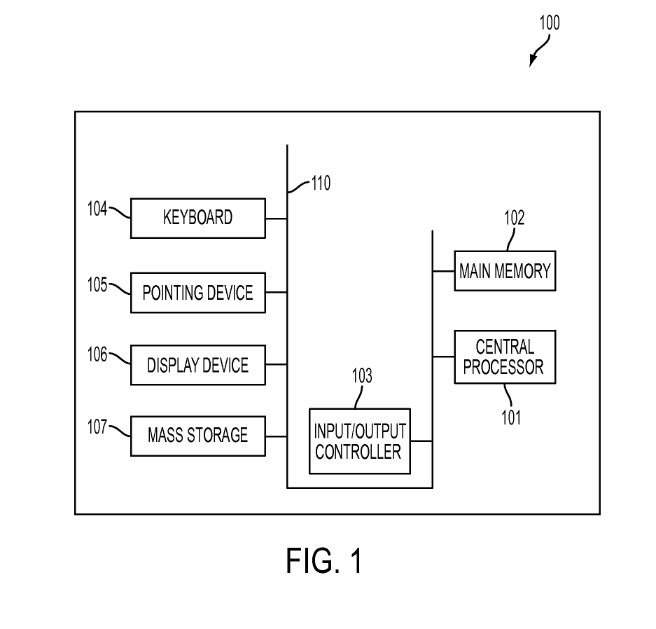

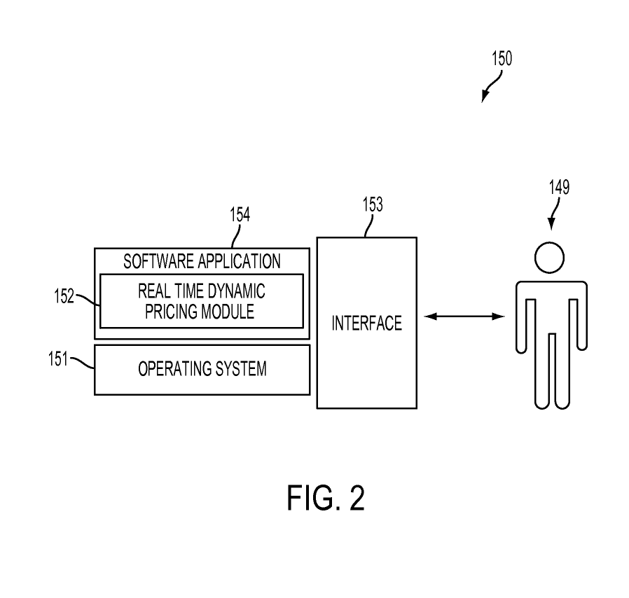

FIGS.1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, pen device, etc.), a display device 106, and mass storage 107 (e.g., a hard disk). A USB (Universal Serial Bus) and/or other peripheral connections may also be electronically connected to or incorporated with data-processing system 100 and communicate electronically with components of data-processing system 100 via a system bus 110. As illustrated, the various components of data-processing system 100 can communicate electronically through the system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may he “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

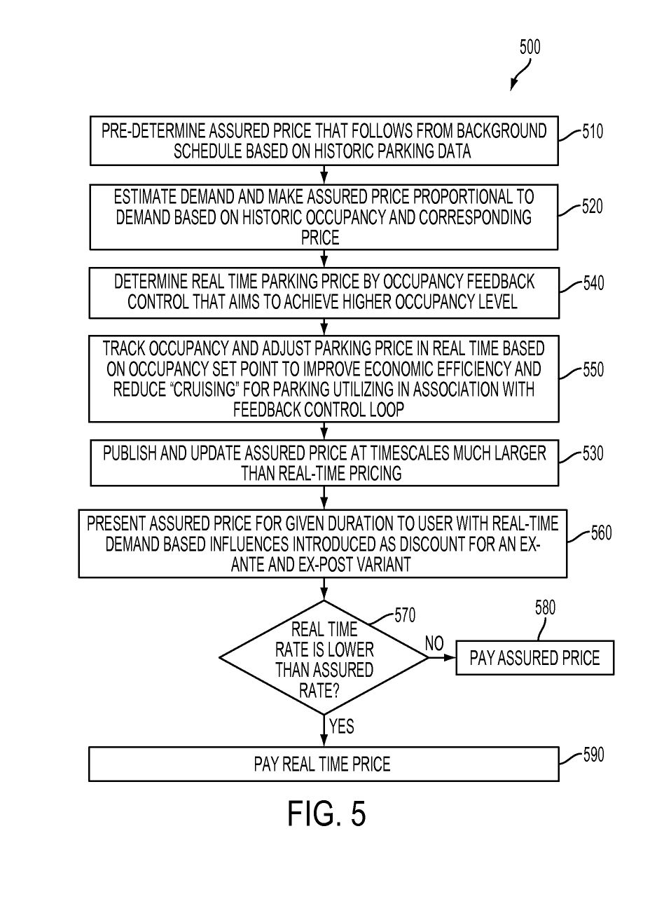

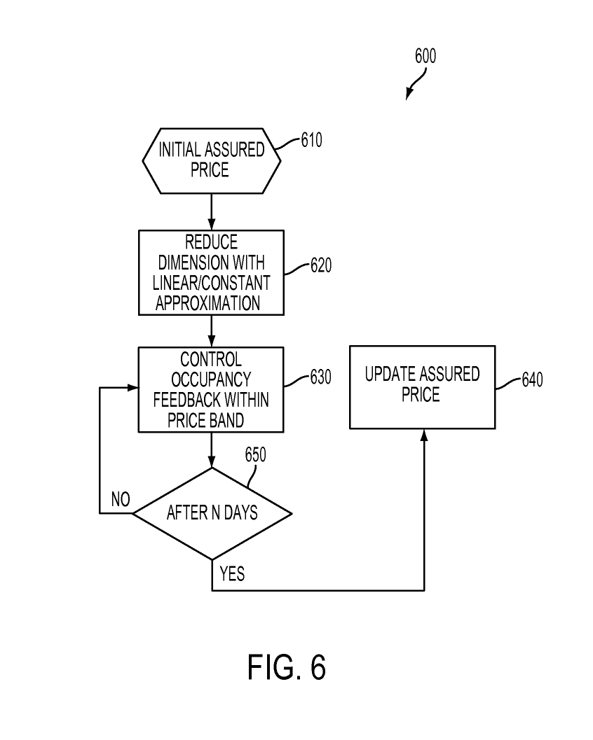

The interface 153, which is preferably a graphical user interface (GUI), can serve to display results, whereupon a user may supply additional inputs or terminate a particular session. In some embodiments, operating system 151 and interface 153 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 151 and interface 153. The software application 154 can include, for example, a real-time dynamic pricing module 152 for managing vehicle parking price by combining a background pricing schedule with a real time occupancy feedback control and a price assurance. The real-time dynamic pricing module 152 can include instructions such as those of methods 500 and 600 as discussed herein with respect to FIGS. 5-6.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, Unix, Linux, and the like.

In general, the disclosed embodiments describe real time dynamic vehicle parking price management methods, systems and processor-readable media. Two factors can be considered in determining the parking price: the real time occupancy level and the historic parking demand. An assured price that follows from a background schedule can be pre-determined based on a historic parking data. Future demand can be estimated based on the historic occupancy data and price, and the assured price can be made proportional to the estimated demand. Furthermore, the assured price can be simplified to be intuitive and easy to remember. A real time parking price can be determined by an occupancy feedback control. A controller in association with a feedback control loop can be employed to track the occupancy and to suggest the parking price in real time based on an occupancy set point to improve economic efficiency and reduce cruising for parking. The parking price is a combination price such that the real time control price is bounded by the assured price. The assured price can be published and updated at timescales much larger than the real-time pricing. The assured price for a given duration can be presented to the user with real-time demand based influences introduced as a discount for an ex-ante and ex-post variant,

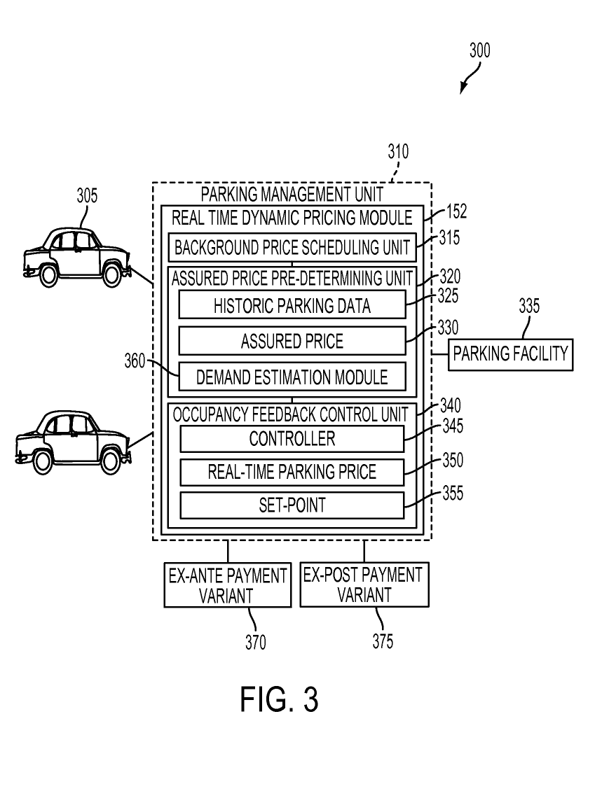

FIG. 3 illustrates a block diagram of real time dynamic vehicle parking price management system 300, in accordance with the disclosed embodiments. Note that in FIGS. 1-10, identical or similar blocks are generally indicated by identical reference numerals. The dynamic vehicle parking price management system 300 generally includes a parking management module or unit 310 that combines a background pricing schedule with a real time occupancy feedback control and a price assurance. The dynamic vehicle parking price management system 300 provides a higher total utility to park, for example, one or more vehicles 305 in a parking facility 355 and increase the economic efficiency of parking usage. The parking management unit 310 can include a number of units or modules such as, for example, parking management unit 310 and occupancy feedback control unit or module 340.

It can be appreciated that unit 310 and/or modules 152, 340, etc., can be implemented in the context of a data-processing system such as system 100 shown in FIG. 1 and/or system 150 shown in FIG. 2. Such modules are preferably implemented as software modules processed by, for example, a processor such as processor 101 and/or in the context of a software application such as software application 154. For example, the real-time dynamic pricing module 152 can be incorporated as software modules with respect to the software application 154 shown in FIG. 2. The same holds true for module 340, etc., shown in FIG. 3.

In any event, the real time dynamic pricing module 152 can be configured to include a background price scheduling unit 315, and an assured price pre-determining unit 320. The assured price pre-determining unit 320 can include a module 325 for generating historic parking data, and a module 330 for calculating/generating an assured price. The assured price pre-determining unit or module 320 can also include a demand estimation module 360. The real time dynamic pricing module 152 can communicate with the occupancy feedback control unit or module 340. The occupancy feedback control unit 340 can include, for example, a controller 345, a real-time parking price 350, and a set-point module 355.

The assured price pre-determining unit 320 can pre-determine an assured price 330 from the background price scheduling unit 315 based on historic parking data 325. The assured price pre-determining unit 320 obtains the assured price 330 from modeling and simulation with the historic parking data 325 and estimates a demand utilizing a demand estimation module 360. The assured price 330 can be made proportional to the demand based on a historic occupancy and corresponding price. The assured price pre-determining unit 320 iteratively updates the assured price 330 to an upper bound to control prices in past N days. The assured price 330 can be made smooth and intuitive with averaging and approximation. The assured price pre-determining unit 320 publishes and updates the assured price 330 at timescales much larger than a real-time pricing. Note that the assured price 330 can be updated every month, depending upon design considerations.

The occupancy feedback control unit 340 determines a real time parking price 350 to achieve higher occupancy level. A controller (PID controller) 345 in association with the feedback control unit 340 can be employed to track the occupancy and to adjust the parking price 350 in real time based on an occupancy set point 355 to improve the economic efficiency and reduce “cruising” for parking. The occupancy feedback control unit 340 presents the assured price 330 for a given duration to a user with real-time demand based influences introduced as a discount for an ex-ante and ex-post variant 370 and 375. A real-time feedback based off-set can be employed for an entire parking duration and smoothed out assuming a regression to the mean. Variations in parking demand can be addressed by the controller 345 and the controller 345 can be retrieved in the limit of no-assurance and no smoothing.

The system 300 can be utilized by the ex-ante payment variant 370 and the ex-post payment variant 375. In the ex-post payment variant 370, an off-set to a base schedule can be computed and a final price can be provided by an integral of the real-time rate (possibly bounded by the assured rates at certain periods). The price can be presented as a discount to the assured price 330. In the ex-ante variant 375, the rates in the background schedule can be adjusted based on a difference between expected and observed demand at the start of the parking event. An assurance can be employed to bind the total parking price. The offset to the rates can be smoothed to reflect an assumed regression to the mean demand.

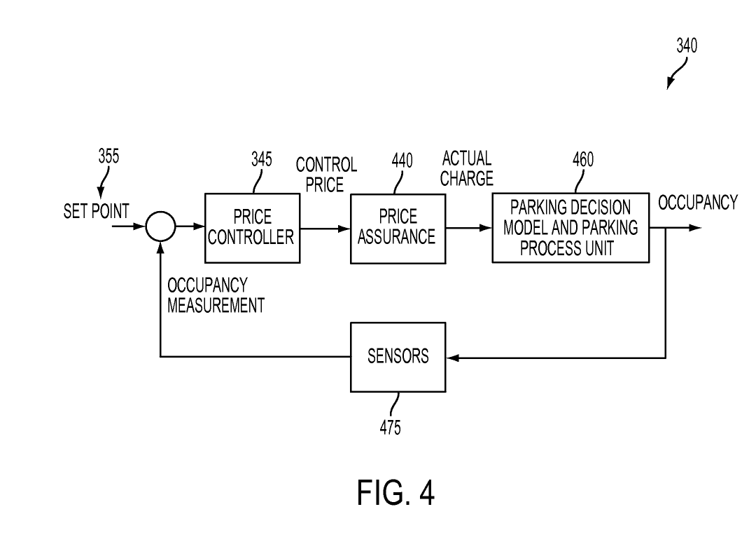

FIG. 4 illustrates a block diagram of the occupancy feedback control unit 340 with price assurance 440, in accordance with the disclosed embodiments. The occupancy feedback control unit 340 includes the price controller 345 with price assurance 440, a parking decision model and parking process unit 460, and occupancy/presence sensing devices 475. The controller 345 can be employed to adjust the parking price which can influence the user decision to park or not so that an occupancy can approach to the set point 355 (e.g., ˜85%). The occupancy/presence sensing devices 475 in a parking facility permits a parking control engine to track the occupancy and adjust the price in real time. The parking demand varies all the time and the days with similar demand can be grouped as one mode and each model can be dealt separately.

For example, all weekdays can be defined as one mode and weekend as another mode. For similar modes, the demand varies in a narrow range so that the controller 345 can be employed to address the variations. Note that the controller 345 can be, for example, a PID controller and the PID controller can be retrieved in the limit of no-assurance and no smoothing. The drivers with higher valuation can always determine a parking space with real time dynamic pricing. The total daily utility of the dynamic pricing is consistently higher than that of the fixed price schedule.

FIG. 5 illustrates a high level flow chart of operations illustrating logical operational steps of a method 500 for managing real time dynamic vehicle parking price by combining the background pricing schedule with the real time occupancy feedback control and the price assurance 440, in accordance with the disclosed embodiments. Initially, as indicated at block 510, the assured price 330 that follows from the background schedule can be pre-determined based on the historic parking data 325. The demand can be estimated and the assured price 330 can be made proportional to the demand based on historic occupancy and corresponding price, as shown at block 520.

Thereafter, as illustrated at block 540, the real time parking price 350 can be determined by the occupancy feedback control to achieve higher occupancy level. The occupancy can be tracked and the parking price can be adjusted in real time based on the occupancy set point 355 to improve economic efficiency and reduce “cruising” for parking utilizing in association with feedback control loop, as shown at block 550. The assured price 330 can be published and updated at timescales much larger than the real-time pricing, as indicated at block 530. The assured price 330 for a given duration can be presented to the user with real-time demand based influences introduced as a discount for the ex-ante and ex-post variant 370 and 375, as indicated at block 560.

Next, a determination can be made whether the real time price 350 is lower than the assured 330, as illustrated at block 570. If the real time rate 350 is lower than the assured rate 330, the real time price 350 can be paid, as shown at block 590. If the real time rate 350 is higher than the assured rate 330, the assured price 330 can be paid, as indicated at block 580.

FIG. 6 illustrates a high level flow chart of operations illustrating logical operational steps of a method 600 for integrating price assurance and occupancy control, in accordance with the disclosed embodiments. The initial assured price 330 is given by modeling and control with the historic occupancy data, as indicated at block 610. The initial assured price 330 can be simplified with averaging and approximation, as depicted at block 620. The dimension can be reduced utilizing a linear/constant approximation such as, for example, adaptive piecewise constant approximation (APCA). The occupancy feedback can be controlled within price band, as shown at block 630. A determination can be made whether the assured price 330 is updated every N days, as depicted at block 650. If the assured price 330 is not updated every N days, the occupancy feedback within price band can be controlled. Otherwise, the assured price 330 can be updated, as shown at block 640.

The price curve produced by the occupancy control can be element-wise upper bounded by the assured price. The assured price 330 can be updated every N days by counting how often the assured price 330 has been ‘pushed’ by the control price. With the actual price of the past N days, a histogram of the overlaps between the actual price curve and the assured price 330 can be considered to make the update proportional to the density of the overlaps. Otherwise, the element-wise upper bound of the control price can be employed as the new assured price 330.

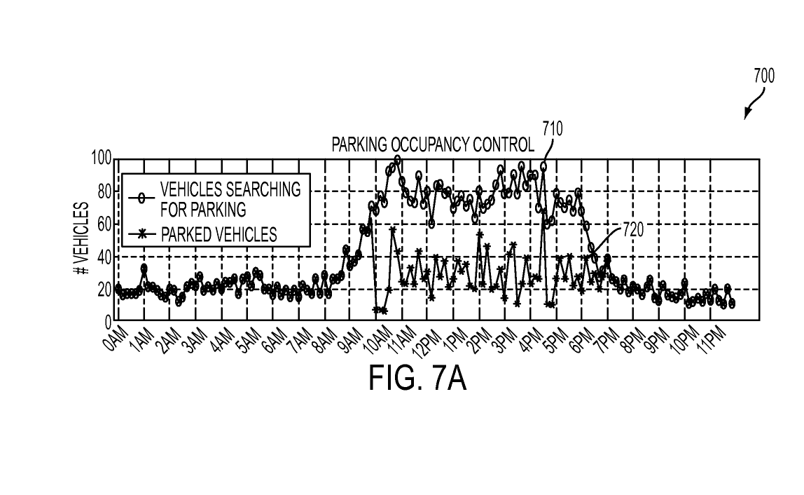

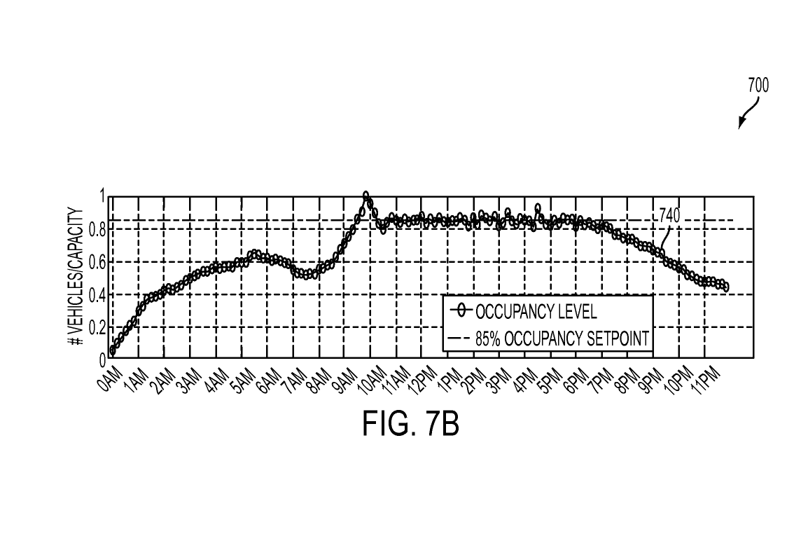

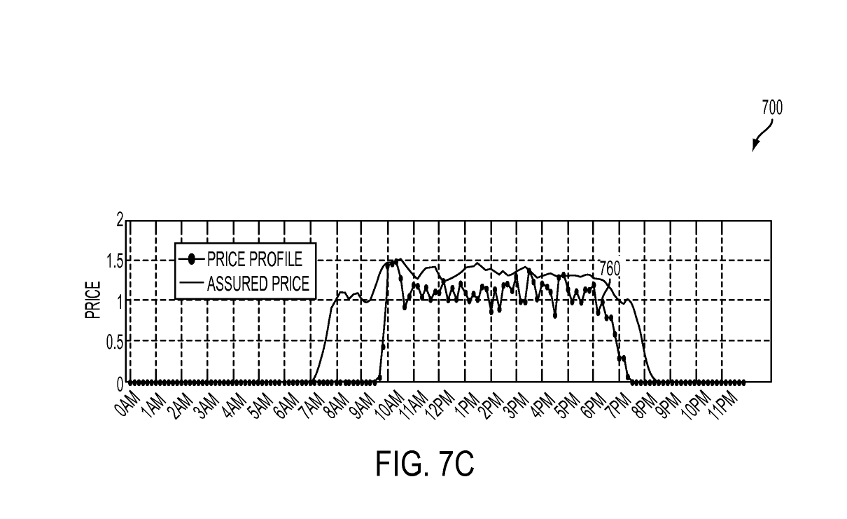

FIGS. 7A-C illustrate a graph 700 depicting simulation of an occupancy control with a smoothed assured price, in accordance with the disclosed embodiments. The circles 710 represent the demand and the curve 760 is the control price, which is upper bounded by the predetermined assured price. The curve 720 represents the realized parking with this price. The circles 740 represent the occupancy, which is controlled to 85% of the capacity. In this example, the price updates every 15 minutes. The graph 700 shows that the controller provides good output performance while the control price stays below the assured price.

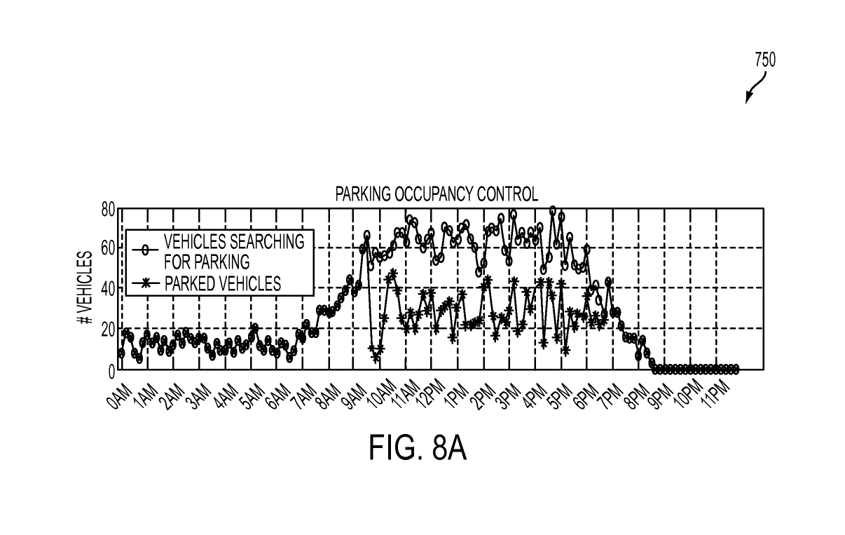

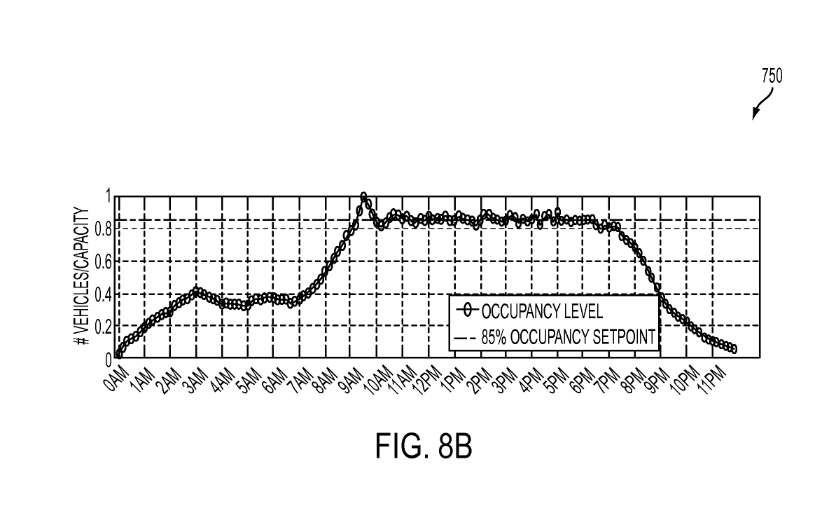

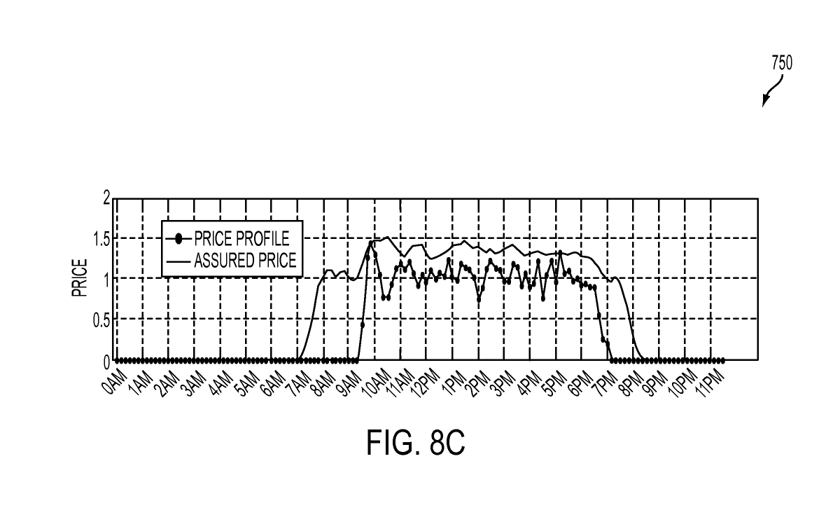

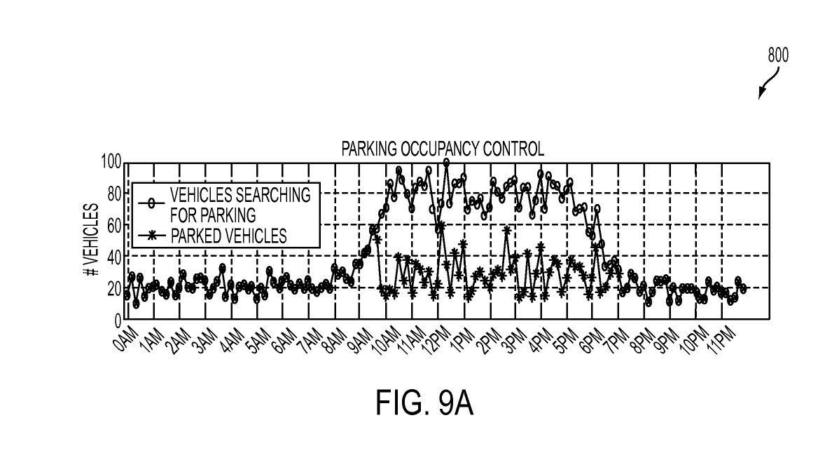

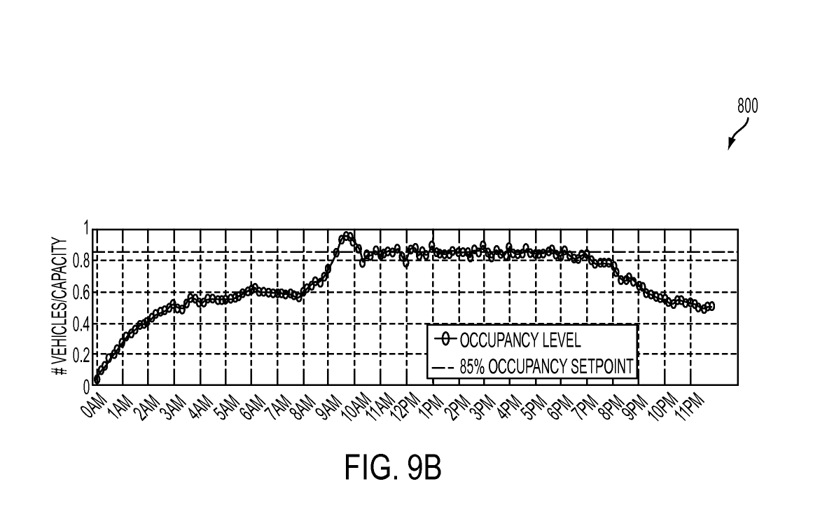

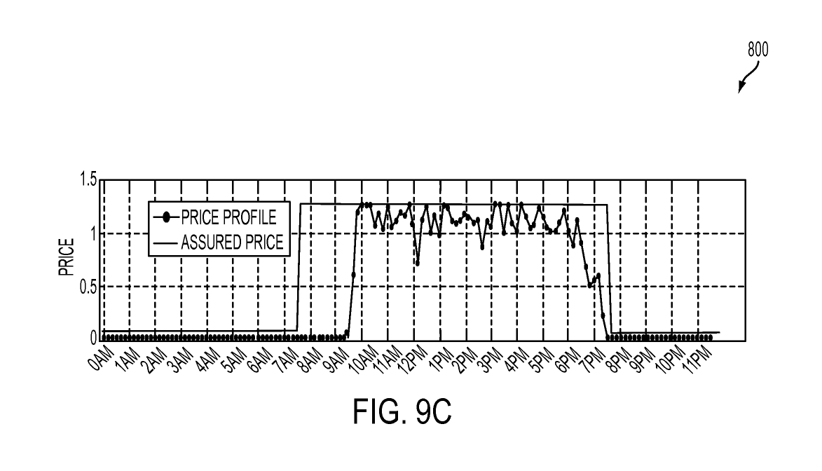

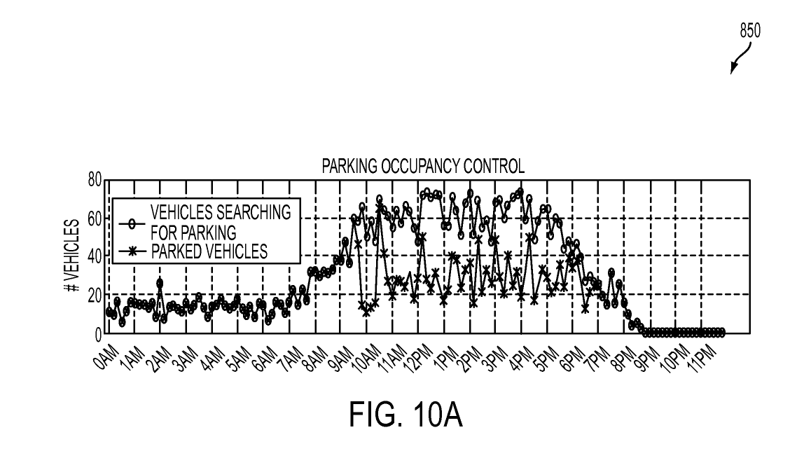

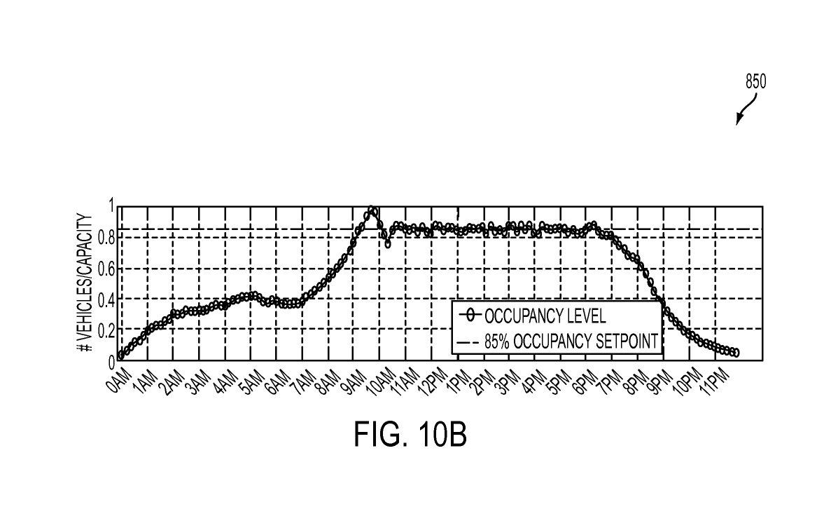

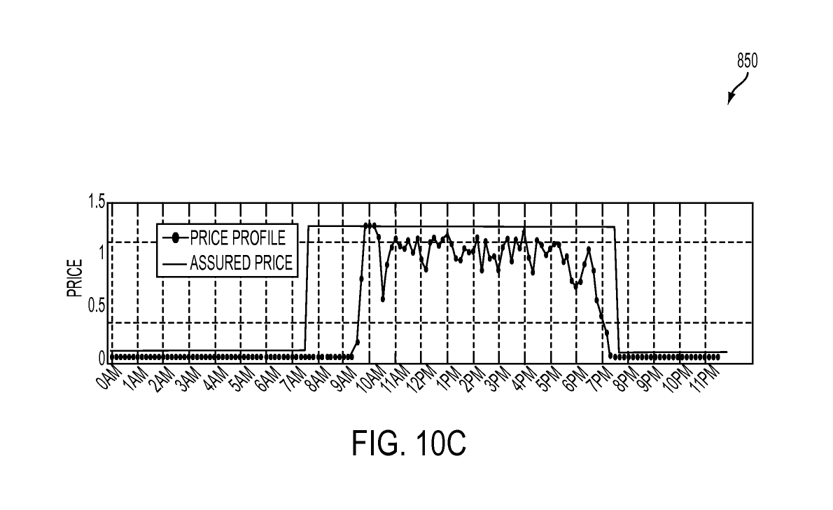

FIGS. 8A-C illustrate a graph 750 depicting simulation of the occupancy control with the smoothed assured price with respect to a different day with different demand, in accordance with the disclosed embodiments. The graph 750 shows that the controller is adaptive to the demand variation. FIGS. 9A-C illustrate a graph 800 depicting simulation of an occupancy control with a piecewise simplified assured price, in accordance with the disclosed embodiments. FIGS. 10A-C illustrates a graph 850 depicting simulation of an occupancy control with a piecewise simplified assured price with respect to different daily demand, in accordance with the disclosed embodiments. The graph 850 shows the controller provides good occupancy performance with the simplified constraint. Such an approach reduces the parking price uncertainty while maintain good occupancy performance and increases the economic efficiency of the parking usage.

Based on the foregoing, it can be appreciated that a number of embodiments, preferred and alternative, are disclosed herein. For example, in one embodiment, a vehicle parking price management method is disclosed which can include the steps of: pre-determining an assured price that follows from a background schedule based on historic parking data and estimating a demand wherein the assured price is proportional to the demand based on the historic parking data and price; determining a real time parking price via an occupancy feedback control and track occupancy and adjust a parking price in real time based on an occupancy set point; and publishing and/or updating the assured price at timescales larger than the real-time and presenting the assured price for a given duration to a user with a real-time demand based influence introduced as a discount for an ex-ante variant and an ex-post variant.

In another embodiment, steps or logical operations can be implemented for initially obtaining the assured price from a modeling and simulation approach wherein the assured price is made smooth and intuitive with averaging and approximation; and iteratively updating the assured price to an upper bound to control prices in past N days. In another embodiment, a step or logical operation can be provided for applying a moving average for a smoothing and adaptive piecewise constant approximation for a dimension reduction: In still another embodiment, steps or operations can be provided for updating the assured price by counting a number of times the assured price is pushed by a control price; determining an overlap between an actual price curve and the assured price by a histogram; and/or configuring/making an update proportional to a density of the overlap.

In still another embodiment, a step or logical operation can be implemented for updating the assured price by utilizing an element-wise upper bound of the control price as new assured price. In yet another embodiment, a step or operation can be provided for controlling the parking occupancy to a desired level with rate constrained by a pre-defined rate curve. In still another embodiment, steps or operations can be implemented for paying the real time price if the real time price is lower than the assured time price; and paying the assured time price if the real time price is higher than the assured time price.

In another embodiment, the ex-post payment variant can further include or can be implemented by computing an off-set to a base schedule and providing a final price by an integral of the real-time rate; and presenting the price as a discount to the assured price. In yet another embodiment the ex-post payment variant can include or can be provided by adjusting rates in the background schedule based on a difference between an expected and observed demand at start of a parking event; and smoothing an offset to the rates to reflect an assumed regression to a mean demand wherein the assurance is utilized to bound a total parking price.

In another embodiment, a vehicle parking price management system can be implemented. Such a system can include a processor; a data bus coupled to the processor; and a computer-usable medium embodying computer program code, the computer-usable medium being coupled to the data bus. The computer program code can include instructions executable by the processor and configured, for example, for: pre-determining an assured price that follows from a background schedule based on historic parking data and estimating a demand wherein the assured price is proportional to the demand based on the historic parking data and price; determining a real time parking price via an occupancy feedback control and track occupancy and adjust a parking price in real time based on an occupancy set point; and publishing and updating the assured price at timescales larger than the real-time and presenting the assured price for a given duration to a user with a real-time demand based influence introduced as a discount for an ex-ante variant and an ex-post variant.

In another embodiment, such instructions can be further configured for initially obtaining the assured price from a modeling and simulation approach wherein the assured price is made smooth and intuitive with averaging and approximation; and iteratively updating the assured price to an upper bound to control prices in past N days. In still another embodiment, such instructions can be further configured for applying a moving average for a smoothing and adaptive piecewise constant approximation for a dimension reduction.

In another embodiment, such instructions can be further configured for updating the assured price by counting a number of times the assured price is pushed by a control price; determining an overlap between an actual price curve and the assured price by a histogram; and configuring an update proportional to a density of the overlap. In still another embodiment, such instructions can be further configured for updating the assured price by utilizing an element-wise upper bound of the control price as new assured price. In yet another embodiment, such instructions can be further configured for controlling the parking occupancy to a desired level with rate constrained by a pre-defined rate curve. In still another embodiment, such instructions can be further configured for paying the real time price if the real time price is lower than the assured time price; and/or paying the assured time price if the real time price is higher than the assured time price.

In still another embodiment, such instructions can be further configured for computing an offset to a base schedule and providing a final price by an integral of the real-time rate; and presenting the price as a discount to the assured price. In still another embodiment, such instructions can be further configured for adjusting rates in the background schedule based on a difference between an expected and observed demand at start of a parking event; and smoothing an offset to the rates to reflect an assumed regression to a mean demand wherein the assurance is utilized to bound a total parking price.

In yet another embodiment, a processor-readable medium storing code representing instructions to cause a process for vehicle parking price management can be implemented. Such code can include code to, for example: pre-determine an assured price that follows from a background schedule based on historic parking data and estimating a demand wherein the assured price is proportional to the demand based on the historic parking data and price; determine a real time parking price via an occupancy feedback control and track occupancy and adjust a parking price in real time based on an occupancy set point; and publish and update the assured price at timescales larger than the real-time and presenting the assured price for a given duration to a user with a real-time demand based influence introduced as a discount for an ex-ante variant and an ex-post variant.

In still another embodiment, such code can further include code to: initially obtain the assured price from a modeling and simulation approach wherein the assured price is made smooth and intuitive with averaging and approximation; and/or iteratively update the assured price to an upper bound to control prices in past N days.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A vehicle parking price management method, comprising:
pre-determining an assured price that follows from a background schedule based on historic parking data and estimating a demand wherein said assured price is proportional to said demand based on said historic parking data and price;
determining a real time parking price via an occupancy feedback control and track occupancy and adjust a parking price in real time based on an occupancy set point; and
publishing and updating said assured price at timescales larger than said real-time and presenting said assured price for a given duration to a user with a real-time demand based influence introduced as a discount for an ex-ante variant and an ex-post variant.

2. The method of claim 1 further comprising:
initially obtaining said assured price from a modeling and simulation approach wherein said assured price is made smooth and intuitive with averaging and approximation; and
iteratively updating said assured price to an upper bound to control prices in past N days.

3. The method of claim 1 further comprising applying a moving average for a smoothing and adaptive piecewise constant approximation for a dimension reduction,

4. The method of claim 2 further comprising:
updating said assured price by counting a number of times said assured price is pushed by a control price;
determining an overlap between an actual price curve and said assured price by a histogram; and
configuring an update proportional to a density of said overlap.

5. The method of claim 2 further comprising updating said assured price by utilizing an element-wise upper bound of said control price as new assured price.

6. The method of claim 1 further comprising controlling said parking occupancy to a desired level with rate constrained by a pre-defined rate curve.

7. The method of claim 1 further comprising:
paying said real time price if said real time price is lower than said assured time price; and
paying said assured time price if said real time price is higher than said assured time price.

8. The method of claim 1 further comprising configuring said ex-post payment variant by:
computing an off-set o a base schedule and providing a final price by an integral of said real-time rate; and
presenting said price as a discount to said assured price.

9. The method of claim 1 further comprising configuring said ex-post payment variant by:
adjusting rates in said background schedule based on a difference between an expected and observed demand at start of a parking event; and
smoothing an offset to said rates to reflect an assumed regression to a mean demand wherein said assurance is utilized to bound a total parking price.

10. A vehicle parking price management system, comprising:
a processor;
a data bus coupled to said processor; and
a computer-usable medium embodying computer program code, said computer-usable medium being coupled to said data bus, said computer program code comprising instructions executable by said processor and configured for:
pre-determining an assured price that follows from a background schedule based on historic parking data and estimating a demand wherein said assured price is proportional to said demand based on said historic parking data and price;
determining a real time parking price via an occupancy feedback control and track occupancy and adjust a parking price in real time based on an occupancy set point; and
publishing and updating said assured price at timescales larger than said real-time and presenting said assured price for a given duration to a user with a real-time demand based influence introduced as a discount for an ex-ante variant and an ex-post variant.

11. The system of claim 10 wherein said instructions are further configured for:
initially obtaining said assured price from a modeling and simulation approach wherein said assured price is made smooth and intuitive with averaging and approximation; and
iteratively updating said assured price to an upper bound to control prices in past N days.

12. The system of claim 10 wherein said instructions are further configured for applying a moving average for a smoothing and adaptive piecewise constant approximation for a dimension reduction.

13. The system of claim 11 wherein said instructions are further configured for:
updating said assured price by counting a number of times said assured price is pushed by a control price;
determining an overlap between an actual price curve and said assured price by a histogram; and
configuring an update proportional to a density of said overlap.

14. The system of claim 11 wherein said instructions are further configured for updating said assured price by utilizing an element-wise upper bound of said control price as new assured price.

15. The system of claim 10 wherein said instructions are further configured for controlling said parking occupancy to a desired level with rate constrained by a pre-defined rate curve.

16. The system of claim 10 wherein said instructions are further configured for:
paying said real time price if said real time price is lower than said assured time price; and
paying said assured time price if said real time price is higher than said assured time price.

17. The system of claim 10 wherein said instructions are further configured for:
computing an off-set to a base schedule and providing a final price by an integral of said real-time rate; and
presenting said price as a discount to said assured price,

18. The system of claim 10 wherein said instructions are further configured for:
adjusting rates in said background schedule based on a difference between an expected and observed demand at start of a parking event; and
smoothing an offset to said rates to reflect an assumed regression to a mean demand wherein said assurance is utilized to bound a total parking price.

19. A processor-readable medium storing code representing instructions to cause a process for vehicle parking price management, said code comprising code to:
pre-determine an assured price that follows from a background schedule based on historic parking data and estimating a demand wherein said assured price is proportional to said demand based on said historic parking data and price;
determine a real time parking price via an occupancy feedback control and track occupancy and adjust a parking price in real time based on an occupancy set point; and
publish and update said assured price at timescales larger than said real-time and presenting said assured price for a given duration to a user with a real-time demand based influence introduced as a discount for an ex-ante variant and an ex-post variant.

20. The processor-readable medium of claim 19 wherein said code further comprises code to:
initially obtain said assured price from a modeling and simulation approach wherein said assured price is made smooth and intuitive with averaging and approximation; and
iteratively update said assured price to an upper bound to control prices in past N days.
